(19) United States
(12) Patent Application Publication
(10) Pub. No.: US 2008/0265454 A1
(43) Pub. Date: Oct. 30, 2008

(54) Method and Device for the Manufacture of a Hard Foam

(75) Inventor: Hans Negle, Nahe (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/097,129

(22) PCT Filed: Dec. 6, 2006
(86) PCT No.: PCT/IB06/54624

§ 371 Date: Jun. 12, 2008

(30) Foreign Application Priority Data
Dec. 16, 2005 (EP) 05112339.6

(51) Int. Cl. B29C 43/18

(52) U.S. Cl. 264/45.1

(57) ABSTRACT

The invention relates to a method of manufacturing a hard foam that can be used as a high-voltage insulating material in high-voltage generators and other high-voltage applications. The invention further relates to a device for carrying out such a method. In accordance with the method, a filling material (5) comprising substantially ball-shaped, preferably hollow particles is fed to a container (1). Subsequently, the filling material (5) is compressed by means of a high pressure (Pi). Subsequently, a liquid binder material is injected under high pressure (P2) into the compressed filling material (5) via an injection orifice (7) and is hardened. Preferably the filling material (5) comprises a mixture of relatively large particles having a diameter between 30 and 100 μm and of relatively small particles having a diameter between 5 and 30 μm. The method results in a hard foam having a relatively high density of the ball-shaped particles and a good binding between the ball-shaped parts. As a result, the hard foam is very light, has a high mechanical stability, and has good insulating properties.

The invention relates to a method and a device for the manufacture of a hard foam, which can be used particularly as a high-voltage insulating material in high-voltage generators, as well as such a high-voltage insulating material. In addition, the invention relates to a high-voltage generator provided with an insulating material manufactured in accordance with the invention, which generator is especially suitable for rotating X-ray systems and computer tomography devices. Finally, the invention also relates to an X-ray system or a computer tomography device having such a high-voltage generator.

WO 03/074598 describes a method of manufacturing a syntactic solid foam having a multiplicity of micro balls. In order to obtain as high a packing density of the balls as possible and thus as low a specific gravity of the foam as possible, a mixture of a liquid binder material and the microballs is first prepared in a container during the manufacturing. This mixture is allowed to stand for a specific time, until all the microballs accumulate in a layer on the surface of the binder material. Subsequently, the liquid binder material is drained from the container until the layer of microballs lies on the bottom of the container. Finally, the binder material still present between the microballs is then allowed to harden. To increase the packing density of the microballs and their buoyancy, a thinning agent (acetone) or an additive improving its viscosity and lengthening the hardening time can be added to the liquid binder material.

A disadvantage of this method however is that a thinning agent must be added to the binder material in order to produce a buoyancy sufficient for a high packing density of the microballs. However, this thinning agent leads to the fact that the binding force of the binder material is reduced, so that the manufactured foam has a reduced mechanical stability. A further disadvantage is that the thinning agent, if it is non-reactive as in the case of acetone, has to be removed again, that is to say, has to be gased out.

It is an object of the invention to provide a method of manufacturing a hard foam with which a higher packing density of the ball-shaped particles and consequently a still lower specific gravity of the hard foam can be obtained with relatively high mechanical stability.

Moreover, a method of manufacturing a hard foam should be provided, which has a high high-voltage strength and is consequently particularly suitable for use as a high-voltage insulating material.

Particularly a method is to be provided with which a hard foam having little weight and a high high-voltage strength can be manufactured, so that this is particularly suitable for use in high-voltage generators for rotating X-ray systems such as computer tomographs.

Finally, a device should also be provided with which the method can be executed in a relatively simple way.

This object is achieved in accordance with claim 1 with a method of manufacturing a hard foam, which method has the following steps: providing a filling material having a plurality of at least essentially ball-shaped particles in a container; compressing or compacting the ball-shaped particles; feeding a binder material to the filling material and hardening the binder material.

As elucidated subsequently, the ball-shaped particles can comprise a gas (hollow balls) and/or a solid and/or liquid material and/or can be formed from such materials and/or can be hollows, which are manufactured for example, by an outgasing agent, wherein the ball-shaped particles can also represent a mixture of these kinds of particles. Finally, the particles can also have different shapes instead of a ball shape. Hereinafter, the designation “ball-shaped particles” is to be used uniformly for all these alternatives.

An advantage of this solution is that a very uniform distribution of the ball-shaped particles in the hard foam can be obtained, and in fact particularly also when they have different diameters. This is based essentially on the fact that the ball-shaped particles are compressed or compacted, so that they cannot segregate by sedimentation when the binder material is fed.

Thus, it is also possible to further increase the packing density of the ball-shaped particles and then accordingly reduce the specific gravity of the hard foam further, in fact even without using a thinning agent, which has the aforementioned disadvantages as well as further known disadvantages.

As described in EP 1 176 856 for example, the hard foam manufactured with the method in accordance with the invention is particularly suitable for use in a hybrid insulation of a high-voltage generator for rotating X-ray systems due to its light weight and at least largely constant high-voltage strength over the entire cross-section due to the uniform distribution of the ball-shaped particles.

The dependent claims comprise favorable further embodiments of the invention.

With the embodiments of the method in accordance with the claims 2 and 3 the packing density of the ball-shaped particles can be increased further, wherein the embodiment in accordance with claim 3 is particularly suitable as a high-voltage insulating material.

Claim 4 relates to a material, which is to be preferably used for the ball-shaped particles for reasons of cost and weight, while claim 5 comprises a preferred method of compressing or compacting these particles.

A complete penetration and surrounding of the ball-shaped particles with the polymer matrix can be obtained reliably with the embodiments in accordance with the claims 6 to 8.

As a further possibility, claim 9 comprises producing at least essentially ball-shaped or differently shaped hollows in the filling material.

Claim 10 relates to a preferred embodiment of the method in case the hard foam is to be used as a high-voltage insulation for a high-voltage device.

The claims 11 to 13 relate to arrangements, in which the insulating material manufactured in accordance with the invention can be used particularly favorably. The claims 14 to 17 finally comprise devices, which are favorably suited or designed for implementing the method.

Further details, characteristics and advantages of the invention are apparent from and will be elucidated with reference to the embodiments described hereinafter.

In the drawing:

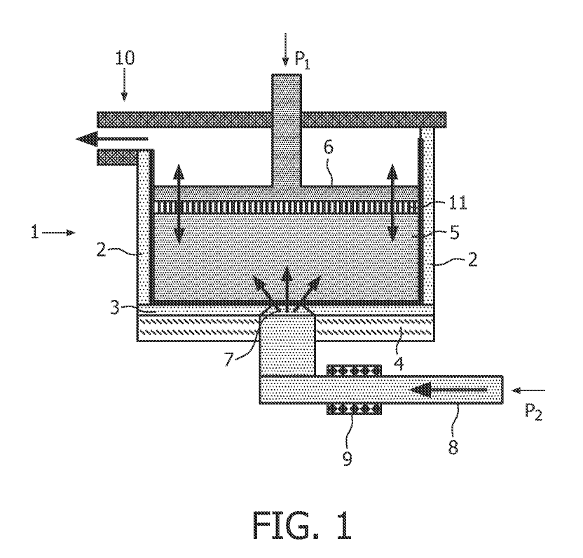

FIG. 1 shows a schematic cross-section through a device for implementing the method in accordance with the invention.

The method in accordance with the invention is to be described hereinafter in connection with the device represented in FIG. 1. However, the method can also be implemented with other devices in the same or similar manner.

The device comprises a container 1, which has sidewalls 2 as well as a bottom 3 and can be heated by means of a heating arrangement (for example, in the form of electrical heating plates on the side walls 2 and/or the bottom 3).

The contents of the container 1 can be subjected to a mechanical vibrating movement. For this purpose, a known vibration device 4 is arranged for example on the bottom 3 of the container 1, which vibration device 4 can also be an ultrasonic exciter for example.

The hard foam manufactured with the method in accordance with the invention, comprises essentially as a binder material (basic substance) a polymer or a resin matrix for example, which has a dielectric constant ∈ᵣ of approximately 3 to 4, as well as a filling material with at least essentially ball-shaped particles, which preferably comprise hollow balls.

First, a mixture 5 of these ball-shaped particles preferably having different diameters is poured into the container.

In order to obtain a particularly high packing density of the ball-shaped particles in the polymer matrix, a mixture 5 of large and small ball-shaped particles is used particularly, wherein the respective diameters are selected in such a way that the space between the large ball-shaped particles is filled out by the small ball-shaped particles to as large an extent as possible.

For this purpose, the ratio between the average diameters of the small and the large ball-shaped particles is preferably selected to be between approximately 1:2 and approximately 1:10 and particularly preferably at approximately 1:7.

Hollow balls having a diameter in the range between approximately 5 μm and approximately 100 μm have proven to be particularly suitable for applications of the hard foam as a high-voltage insulating material.

In order to obtain a particularly high packing density in accordance with the foregoing measurement rule while using the mixture 5 of large and small hollow balls, the diameter or average diameter of the large hollow balls is then preferably in the range between approximately 30 μm and approximately 100 μm and the diameter or the average diameter of the small hollow balls is preferably in the range between approximately 5 μm and approximately 30 μm.

The hard foam has a very low specific gravity with high mechanical strength due to the high packing density of the hollow balls. This is particularly of great importance for using the hard foam as a high-voltage insulation in high-voltage generators for rotating X-ray systems such as computer tomographs.

The ball-shaped particles can be made of, for example glass, a (capacitor) ceramic or phenolic resin, an acrylonitrile copolymer or any other insulating material like for example a thermoplastic or a duroplastic material (plastic).

The hollow balls can contain a gas for example, sulfur hexafluoride (SF₆) or isopentane or other gases, which can also be fed under an increased pressure, in order to increase the high-voltage strength and the strength vis-à-vis an external pressure effect also. Depending upon the use of the hard foam, ball-shaped particles that comprise a solid and/or a liquid material and/or are formed by such a material can also be used instead of at least a part of the hollow balls.

The manufacturing of the ball-shaped particles takes place with a known method, such that it does not need to be dealt with in greater detail.

The dielectric constant of the hard foam can be adapted or changed in a desired manner by a suitable choice of the material of which the ball-shaped particles are made, by their size and number in the hard foam, as well as by the type of the gas (hollow balls) contained in the ball-shaped particles, and its pressure or the material of the particles.

Thus, for example, the dielectric constant of the hard foam can be reduced much more strongly, the larger the gas portion in the hard foam is. This portion rises with the increasing number and increasing diameter of the hollow balls. Simultaneously, with these two measures, naturally the weight of the hard foam can also be reduced.

On the other hand, the electrical dielectric strength (high voltage strength) of the hard foam can also be increased with as small a diameter of the hollow balls as possible, as well as the suitable choice of the type and the pressure of the contained gas. For this purpose, the gas pressure in the hollow balls as well as their diameter can be co-coordinated in such a way that partial discharge in the hollow balls are avoided in a manner known per se.

By using an adhesion corrector the adhesion of the ball-shaped particles or hollow balls to the filling material, which is particularly a polymer or a resin matrix, can be improved and thus the high-voltage strength of the insulating material can be increased further. In the case where the ball-shaped particles are made of glass or ceramic, the adhesion at the polymer matrix can be increased by silanization by approximately 0.1 to 0.3%. If the ball-shaped particles are made of a plastic, the adhesion at the polymer matrix can be improved by coating the plastic balls with calcium carbonate.

Another problem that arises particularly in connection with the increasing use of high operating frequencies and the reduction of the associated power elements (for example high-voltage transformers, cascades etcetera), as well as the increasingly more compact design of the high-voltage generators, is that charges accumulate on the surface of the solid insulating materials, which changes lead to voltage flash-overs there and a destruction of the insulation arrangement and thus could entail a defect of the high-voltage generator (boundary surface problem).

These charges can be distributed and thus a further increase particularly in the carrying capacity with direct voltage field strengths can be obtained by the fact that some or all the ball-shaped particles, which are formed from an electrically non-conductive material are provided with an electrically conductive coating. It has turned out that with this measure in connection with a uniform distribution of the ball-shaped particles, the volume conductivity of the hard foam can be adjusted in a relatively precise and reproducible way via the selection of the density and/or the size of the ball-shaped particles.

By a suitable selection of these measures, consequently an insulating hard foam can be manufactured, with which a specific field control is possible both as regards the alternating voltage load, namely via the adjustment of the dielectric constant, and as regards the direct voltage load, namely via the adjustment of the specific resistance of the insulating foam.

This has advantages when used in X-ray systems, as the high-voltage generator is generally subjected to a mixed load of direct voltage, alternating voltage and unipolar pulsating voltages, particularly when it is operated in the boundary range of the carrying capacity of the material.

It should further be mentioned that depending upon the electrical requirements on the insulating material, the ball-shaped particles could also have a shape that is only approximately like the ball-shape.

The mixture 5 of ball-shaped particles fed into the container 1 is first compressed or compacted by applying a first pressure P₁.

This can take place for example by passing a gas which is under pressure into the container 1 or in a mechanical way for example, with a pressure plate 6 that is movable relative to the side walls 2 of the container 1 (or with a piston, if the container has a round cross section), when the pressure plate 6 (or the piston) is pressed on the mixture 5 with a first pressure P₁ (for example approximately 2 to 10 bar).

Hence, it is ensured that the large and the small ball-shaped particles are fixed in a uniform blend and thus in a uniform distribution in the entire mixture.

With this measure the ball-shaped particles are also prevented from segregating and settling during the following injection of the binder material (preferably resin) and the subsequent hardening phase in accordance with their different sizes. The sequence of layers thus formed of ball-shaped particles with diameters reducing in the direction of the bottom 3 would have a consequence, namely a substantial impairment of the high-voltage strength of the hard foam at least in the (upper) ranges in which the ball-shaped particles having the larger diameters are located.

With at least one opening or injection nozzle 7 in the bottom 3 and/or one or a plurality of openings in at least one of the sidewalls 2, the binder material (preferably a thin liquid resin) is fed into the container. This takes place preferably with a second pressure P₂, which is exerted with a suitable pump or a ram (not represented). In this connection, the resin-binder material supplied by at least a pipe 8 is heated up preferably by means of a heating sleeve 9 laid around the line 8 to a temperature at which it reaches a minimum viscosity and the gelling process is at least not yet really started (for example approximately 80° C. to approximately 160° C.). By using a thinner, naturally a lower temperature may be sufficient.

In this connection, the resin forms the matrix of the hard foam, which matrix later hardens and has a dielectric constant □ᵣ of approximately 3 to 4.

The resin (or another binder material) is fed with such a quantity and such a pressure P₂ (for example about 2 to 10 bar) that it fills out the still existing gaps between the ball-shaped particles as completely as possible. This can be facilitated in that (if the first pressure P₁ is exerted mechanically) the air present in the gaps or any gas bubbles are sucked off via a vacuum connecting pipe 10 present in the container. In order to prevent the odd ball-shaped particle escaping, a mesh net 11 is preferably laid between the pressure plate 6 and the mixture 5, which mesh net has a mesh size preferably smaller than the smallest diameter of the ball-shaped particles. In this connection, the pressure plate 6 can be provided with openings, so that a sufficiently large suction cross-section is available, without impairing the squeezing or the compressing of the mixture 5.

If necessary, the compression or the compacting during the feeding of the binder material can also be continued with different first pressures P₁.

During the feeding of the binder material the vibration device 4 is preferably activated.

The vibration, particularly with ultrasound, leads on the one hand to the fact that the small ball-shaped particles fill out the gaps between the large ball-shaped particles still better, and on the other hand has the consequence that the friction forces (shearing forces) between the resin and the ball-shaped particles are so widely reduced that a uniform and complete penetration of the mixture 5 and surrounding or wetting of all the comprised particles with the binder material is achieved.

For further optimization of this penetration and wetting, a known thinning and/or wetting agent (for example, a dispersion additive for controlling the thixotropy or for reducing the viscosity) can be added to the resin binder material, with which the adhesion of the resin to the surfaces of the ball-shaped particles is increased or the wetting is further improved by increasing the surface tension.

Preferably, non-reactive agents such as acetone, ethanol, denatured alcohols, and thinner etcetera are used as thinning agents. In contrast, if any outgasing and formation of bubbles is unwanted, reactive thinning agents are used. In the case of epoxy resins, such reactive thinning agents are for example very highly liquid, short-warp epoxy resins based on bisphenol A with only bifunctional groups, with which no transverse cross-linkages develop, only linear cross-linkages.

Moreover, the thinning agent can likewise contribute to the fact that the small and the large ball-shaped particles mix better still with each other and its packing density is thereby further increased.

This may additionally or alternatively also be achieved with an appropriate surface coating of the ball-shaped particles, by which these slide better together. For this purpose, silane coatings or also nano-quartz can be used for example, which have the advantage that they do not act as releasing agents and do not degrade the later adhesion to the polymer matrix. Nano-quartz are quartz sands (for example, pyrogenic silicic acid, silicon dioxide) in the nanometer range, which are partially used as thixotropy agents also. For example, modified siloxane copolymers (for example, polyether modified methylpolysiloxane copolymer) come into consideration as silanes. They reduce the surface tension and thereby improve the wetting characteristics between the resin and glass or ceramic balls.

As a further measure, the ratio between the extent of the first and the second pressure P₁, P₂ and the temperature of the injected binder material are adjusted to each other in such a way that a highest possible penetration and at the same time as uniform and complete a wetting of the ball-shaped particles as possible are obtained.

The container 1 is preferably measured in such a way that if the hard foam is used as a high-voltage insulator, the components to be insulated from each other for example those of a high-voltage network or of another high-voltage device find a place in it, so that the insulator can take up these components after the hardening. For this purpose molds are inserted into the container 1 before the mixture is fed, with which molds the hollow spaces, channels or other recesses needed for the components of the device are kept free.

Such hollow spaces or channels may also be provided for an insulating liquid, if a hybrid insulation is to be implemented, as described for example in EP 1 176 856.

If necessary, the insulator can also be composed of two or a plurality of layers, to facilitate the installation of the components.

Since the hard foam or insulator need not be cast, the filling degree with ball-shaped particles can be increased to beyond the limit value given for obtaining a casting capacity of approximately 45 to 50 percent by volume to approximately 70 to 80 percent by volume. This corresponds to a density of the hard foam or insulator of only about 0.1 to 0.2 g/cm³.

On the one hand, this clearly increased filling degree entails an appropriate reduction of the specific gravity of the insulator. On the other hand, by specifying a desired maximum weight, the portion of the small ball-shaped particles can be increased, by which the weight increases compared to the large ball-shaped particles with the same filling degree. Thus, the high-voltage strength can be increased again, as this generally increases with the reducing diameter of the ball-shaped particles or hollow balls.

With a further embodiment of the method of manufacturing the hard foam in accordance with the invention, a plurality of hollow spaces are manufactured in the filling material by an outgasing agent fed into the filling material.

These hollow spaces can particularly replace the small ball-shaped particles at least partially or fill the still existing gaps between the ball-shaped particles and thus further reduce the specific gravity.

For this purpose, an outgasing agent is added to the binder material injected into the container 1, which outgasing agent forms the gas bubbles during the hardening of the binder material or the evacuating of the container 1, which gas bubbles can take an approximately desired size with the suitable choice of the agent and the temperature and pressure ratios.

Such an agent may be a non-reactive thinning agent like for example acetone, whose outgasing is induced by the exotherm of the hardening process of the resin. Naturally, other outgasing agents can also be used, which are not provided for the thinning of the resin, wherein the outgasing can also be induced in another way, like for example by thermal or another effect from outside or in a catalytic way etcetera.

Due to the high packing density of the ball-shaped particles, which is obtained by squeezing the ball-shaped particles in the container 1 and if necessary by the further measures described above, only a relatively small amount of binder material is necessary for filling out the gaps between the ball-shaped particles completely. This, in turn entails that a high exothermic resin can also be used as a binder material, which has the advantage that it is relatively thin-bodied and consequently surrounds the ball-shaped particles reliably, on the other hand, however, due to its small quantity, does not generate so much heat with the hardening, so that there is a danger of a destruction of the ball-shaped particles, particularly if these are manufactured from plastic.

The hard foam manufactured in the form of the high-voltage insulating material is suitable due to its light weight (and its good insulating properties) not only for rotating X-ray systems but also for stationary ones. In this connection, it can also be used as a molding material, which helps to take up the relevant components in appropriately dimensioned recesses in the plastic material, wherein the components can be fixed for example by a tight fit or with simple fixing agents.

The binder material is preferably a polymer matrix. However, depending upon the use of the hard foam, another material could be also injected as a binder material into the container 1, like for example a liquid metal or the like.

The hard foam manufactured with the method in accordance with the invention is suitable for use not only as an insulating material, but also as a reinforced building material having a very low specific gravity.

1. A method of manufacturing a hard foam having the following steps:
providing a filling material having a plurality of at least essentially ball-shaped particles in a container;
compressing or compacting the ball-shaped particles;
feeding a binder material to the filling material; and
hardening the binder material.

2. A method as claimed in claim 1, in which the ball-shaped particles comprise a number of first and second hollow balls, wherein the average diameter of the first hollow balls is larger by a factor of between approximately 2 and approximately 10 than the average diameter of the second hollow balls.

3. A method as claimed in claim 2, in which the first hollow balls have an average diameter between approximately 30 μm and approximately 100 μm and the second hollow balls have an average diameter between approximately 5 μm and approximately 30 μm.

4. A method as claimed in claim 1, in which the ball-shaped particles are manufactured from plastic, glass or ceramic.

5. A method as claimed in claim 1, in which the ball-shaped particles are compressed or compacted by applying a mechanical or gas pressure.

6. A method as claimed in claim 1, in which the binder material is a resin, whose fluidity is increased by heating before being fed to the filling material.

7. A method as claimed in claim 1, in which before and/or during the feeding of the binder material, the filling material is subjected to a negative pressure, with which air or other gases are sucked off.

8. A method as claimed in claim 1, in which the filling material is subjected to a mechanical vibration before and/or during the feeding of the binder material.

9. A method as claimed in claim 1, in which the ball-shaped particles comprise a number of hollows, which are generated by an outgasing agent fed to the filling material.

10. A method as claimed in claim 1, in which the hard foam is at least a part of a high-voltage insulation for a high-voltage device and in which the ranges necessary for the components of the high-voltage device are kept free of filling material by the molds inserted into the container.

11. A high-voltage insulating material, which is manufactured in accordance to claim 1.

12. A high-voltage generator particularly for use in rotating X-ray systems having a high-voltage insulating material as claimed in claim 11.

13. An X-ray system having a high-voltage generator as claimed in claim 12.

14. A device for implementing the method as claimed in claim 1 having a container (1) for feeding the filling material comprising a plurality of at least essentially ball-shaped particles (5) as well as a binder material, wherein the container has a mechanism (6), with which the ball-shaped particles (5) can be compressed or compacted mechanically or by a first pressure P₁ exerted by the gas.

15. A device as claimed in claim 14, having a vibration device (4) with which the contents of the container (1) can be subjected to a mechanically vibrating movement.

16. A device as claimed in claim 14, having a source of negative pressure, with which air or other gases from the filling material comprised in the container (1) can be sucked off.

17. A device as claimed in claim 14, having a supply (8) for the binder material, with which the binder material can be injected into the filling material in the container (1) with a second pressure P₂.
